(19) United States
(12) Patent Application Publication
(10) Pub. No.: US 2008/0037573 A1
(43) Pub. Date: Feb. 14, 2008

(54) Method and apparatus for encoding and distributing media data

(75) Inventor: Guillaume Cohen, Palo Alto, CA (US)

Correspondence Address: RAYMOND R. MOSER JR., ESQ.;MOSER IP LAW GROUP, 1030 BROAD STREET, 2ND FLOOR, SHREWSBURY, NJ, 07702, US

(73) Assignee: VEODIA, INC., Palo Alto, CA (US)

(21) Appl. No.: 11/879,453

(22) Filed: Jul. 17, 2007

Related U.S. Application Data
(60) Provisional application No. 60/837,313, filed on Aug. 11, 2006.

(51) Int. Cl. H04L 12/56

(52) U.S. Cl. 370/412

(57) ABSTRACT

A method and apparatus for encoding and distributing media signals comprising a module for receiving and distributing media data through a communications network, wherein the module performs an encoding process in response to a control signal generated by a controller operating in collaboration with the module.

### CROSS-REFERENCE TO RELATED APPLICATIONS

The present invention claims benefit of U.S. provisional patent application Ser. No. 60/837,313, filed on Aug. 11, 2006, which is herein incorporated by reference. The present application discloses subject matter that is related to U.S. patent application Ser. Nos. ______ filed Jul. 6, 2007, (Attorney Docket Number VEO/002) and ______, filed simultaneously herewith, (Attorney Docket Number VEO/003), which are both herein incorporated in their entireties.

### BACKGROUND OF THE INVENTION

1. Field of the Invention

The present invention generally relates to a method and apparatus for encoding media data and, more specifically, to a media data encoding module for controllably encoding media signals and distributing the encoded signals via a network.

2. Description of the Related Art

Electronic and computer advancements offer a vast selection of technologies for media signal generation, encoding and display. For use in some media distribution systems, such as those disclosed in U.S. patent application Ser. Nos. ______, filed Jul. 6, 2007, (Attorney Docket Number VEO/002) and ______, filed simultaneously herewith, (Attorney Docket Number VEO/003), which are both herein incorporated in their entireties, the media signal encoding process is controlled using an external control signal. These systems supply an external control signal to the media source to control the encoding of the media signals such that the encoded signal (media data) is optimized for transmission by the system. Many media devices, such as cameras, both video and still, do not provide a capability for externally controlling the encoding process that forms a digitally encoded signal (media data) or for remotely recording multimedia data to form a high quality media file.

Therefore, there is a need for an encoding module for use with legacy media sources to facilitate external control of an encoding process performed by the module and/or the remote recording of high quality media files.

### SUMMARY OF THE INVENTION

The present invention is a method and apparatus for encoding media signals comprising a module for receiving and distributing encoded media data, wherein the encoded media data is encoded in response to a control signal generated by a controller operating in collaboration with the module.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 is a block diagram of one embodiment of a media generation and distribution system that operates in accordance with the present invention;

FIG. 2 is a block diagram of a module for encoding and distributing media signals in accordance with one embodiment of the present invention;

FIG. 3 is a flow diagram depicting an exemplary embodiment of a method of operation of the module of FIG. 2;

FIG. 4 is a flow diagram depicting an exemplary embodiment of a method of the module re-sending dropped media data packets; and

FIG. 5 depicts an exemplary hand-held implementation of the module within a media data distribution system.

### DETAILED DESCRIPTION

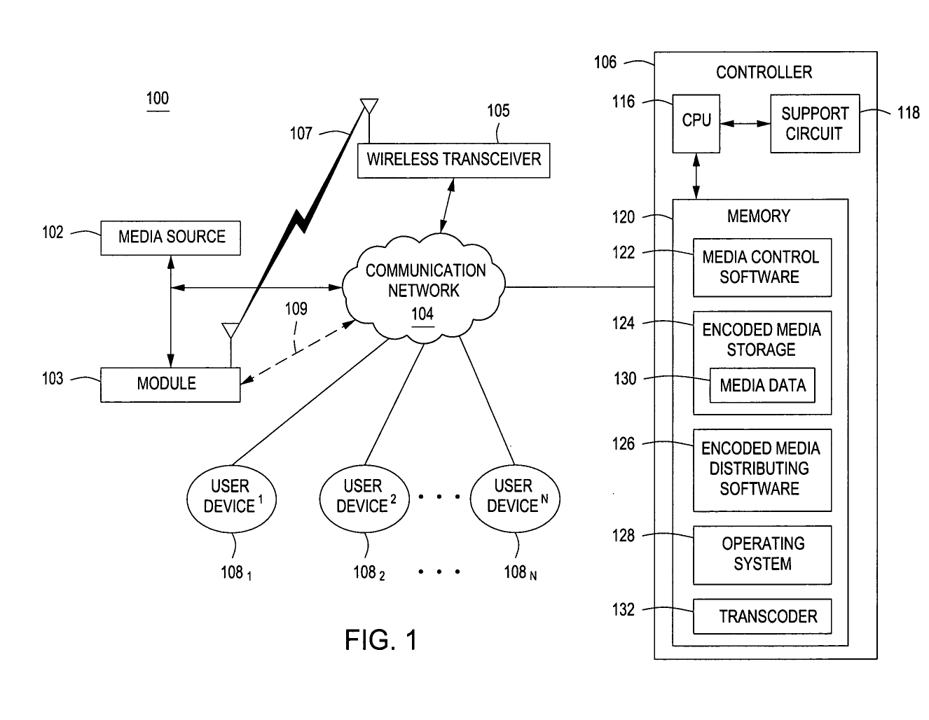

FIG. 1 is a block diagram of one embodiment of a media generation and distribution system 100 that operates in accordance with the present invention. This figure only portrays one variation of the myriad of possible system configurations. The present invention can function in a variety of computing environments; such as, a distributed computer system, a centralized computer system, a stand alone computer system, or the like. One skilled in the art will appreciate that the system 100 may or may not contain all the components listed below.

The media generation and distribution system 100 comprises at least one media source 102, an encoding module for the media source 103 at least one communication network 104, a controller 106, and one or more user devices 108₁, 108₂ . . . 108ₙ. The module 103 is coupled to the media source 102 and is coupled to the communication network 104. The module 103 may be wirelessly coupled to the network through path 107 to a wireless transceiver 105 and/or coupled to the network 104 via a cable 109. The controller 106 is coupled to the communication network 104 to allow media data produced by the encoding module 103 to be transmitted to the controller 106 and then distributed to the user devices 108₁, 108₂ . . . 108ₙ. Similarly, the user devices 108₁, 108₂ . . . 108ₙ are coupled to the communication network 104 in order to receive media data distributed by the controller 106. The communication link between the communication network 104 and the encoding module 103, the controller 106 or the user devices 108₁, 108₂ . . . 108ₙ may be a physical link, a wireless link, a combination there of, and the like.

In operation, the media source 102 (e.g., a legacy video camera), produces an analog or digital media signal. The encoding module 103 encodes the media signal in accordance with a control signal produced by the controller 106. The control signal is dynamically adjusted to accommodate the variation in the encoding and distribution environment, as described in U.S. patent application Ser. No. ______, filed Jul. 6, 2007 (Attorney Docket No. VEO/002), which is incorporated herein by reference in its entirety. The encoded signal (media data) is distributed by the controller 106 as well as, in one embodiment, stored by the controller such that the controller 106 may operate as a video server. The controller 206 distributes the media data through the network 104 to the user devices 108₁, 108₂ . . . 108ₙ.

The controller 106 comprises at least one server. In another embodiment, the controller 106 may comprise multiple servers in one or different locations. The controller 106 may be remotely located from the encoding module 103; however, in some embodiments, some or all of the functions performed by the controller 106 as described below, may be included within and performed by the encoding module 103. The controller 106 comprises at least one central processing unit (CPU) 116, support circuits 118, and memory 120.

The CPU 116 comprises one or more conventionally available microprocessors or microcontrollers. The microprocessor may be an application specific integrated circuit (ASIC). The support circuits 118 are well known circuits used to promote functionality of the CPU 116. Such circuits include, but are not limited to, a cache, power supplies, clock circuits, input/output (I/O) circuits and the like. The memory 120 contained within the controller 106 may comprise random access memory, read only memory, removable disk memory, flash memory, and various combinations of these types of memory. The memory 120 is sometimes referred to as main memory and may, in part, be used as cache memory or buffer memory. The memory 120 may store an operating system 128, the encoding control software 122, the encoded media storage 124, encoded media distributing software 126, media data 130, and transcoder 132.

The encoding control software 122 analyzes the environmental characteristics of the system 100 to determine encoding requirements for producing media data that is optimally encoded for distribution and/or to keep track of any dropped data packets to facilitate lossless transmission of the media data as described below. The analysis may include, but is not limited to, a review of connection bandwidth, encoding module 103 requirements, capability or requests, user device types, and the like. After the media control software 122 analyzes the environmental characteristics of the system 100, the state of the system 100 may be altered to accommodate the environmental characteristics. Accordingly, the media control software 122 re-analyzes the environmental characteristics of the system 100 and dynamically alters the encoding parameters for producing media data. Dynamic alteration of the encoding parameters may occur before or during encoding of the media data. For example, if the connection bandwidth changes during the encoding process, the controller acknowledges the bandwidth change and the encoding control software 122 re-analyzes the environmental characteristics of the system 100 to provide updated encoding parameters in response to the altered system characteristics.

In addition, in one embodiment of the invention, if multiple encoding types are requested by a system user, the encoding control software 122 sets the encoding requirements for one encoding type. The transcoder 132, within the controller 106, transcodes the received media data into other encoding type. For example, if a media source 102 or the encoding module 103 user specifies that the media data is to be encoded for a mobile device, a high definition device, and a personal computer, the encoding control software 122 may specify encoding parameters that are compatible with a high definition display. In the background, the transcoder 132 transcodes the high definition encoded media data to mobile device and personal computer display compatible media data. The encoded media storage 124 may archive encoded media data 130 for immediate or future distribution to user devices 108₁, 108₂ . . . 108ₙ. The encoded media distributing software 126 distributes encoded media data 130 to user devises 108₁, 108₂ . . . 108ₙ.

The memory 120 may also store an operating system 128 and media data 130. The operating system 128 may be one of a number of commercially available operating systems such as, but not limited to, SOLARIS from SUN Microsystems, Inc., AIX from IBM Inc., HP-UX from Hewlett Packard Corporation, LINUX from Red Hat Software, Windows 2000 from Microsoft Corporation, and the like.

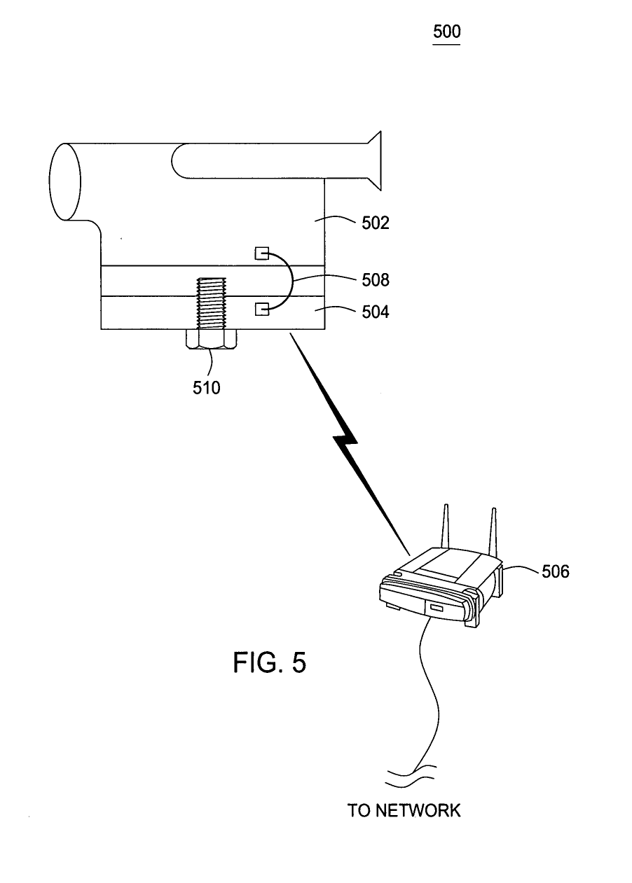

An exemplary implementation and use of the encoding module is shown in FIG. 5. In this embodiment, the media source is a hand-held video camera 502 and the encoding module is an add-on module 504. The module 504 is physically coupled to the bottom of the video camera 502 via a tripod mounting screw 510. The video signal is coupled from the video camera 502 to the module 504 via a cable 508. Alternatively, a BLUETOOTH wireless connection (or other wireless protocol) could be used. To facilitate using the module and camera combination 512 in an untethered manner, the module 504 communicates the media data wirelessly to a base station 506 (e.g., via WiFi or WiMAX). The base station 506 couples the media data to a network (e.g., the Internet). In this manner, the video signal is captured in a conventional manner, yet the signal is encoded and streamed to the Internet as a live media data stream.

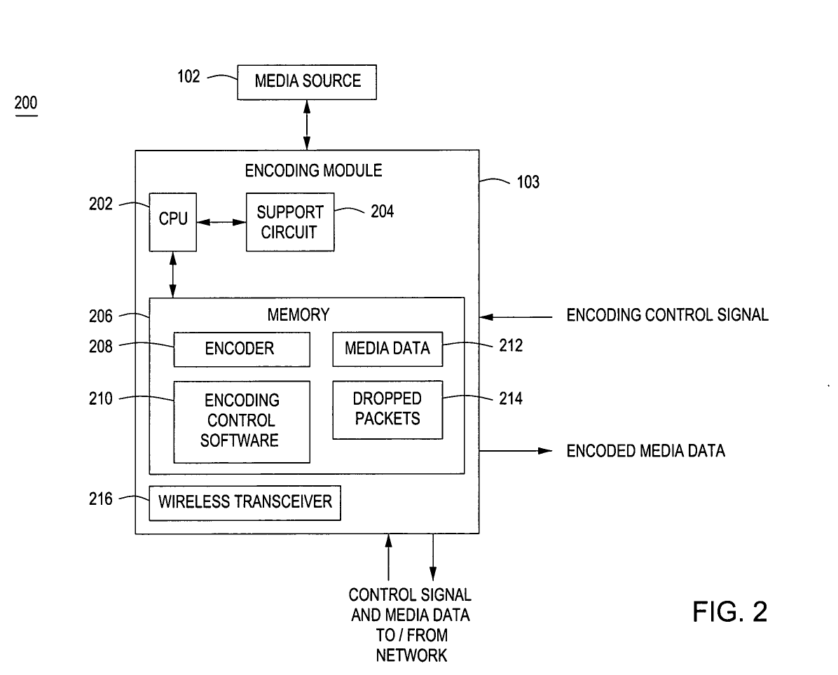

FIG. 2 is a block diagram of one embodiment of the encoding module 103 that operates in accordance with the present invention. The module 103 is coupled to the media source 102 as described with respect to FIG. 1. The module 103 may comprise at least one central processing unit (CPU) 202, support circuits 204, memory 206 and an optional wireless transceiver 216. The module 103 receives a control signal from the communications network 104 and distributes media data to the network 104. The module 103 encodes media signals in compliance with the control signal received from the controller 106. In one embodiment, the module communicates with the controller via a wireless link using the transceiver 216. In this manner, the module 103 forms an add-on component to the media source such that, as media signals are generated, the module encodes and distributes the signals to the controller via a wireless link.

The CPU 202 comprises one or more conventionally available microprocessors or microcontrollers. The CPU 202 may be an application specific integrated circuit (ASIC). The support circuits 204 are well known circuits used to promote functionality of the CPU 202. Such circuits include, but are not limited to, a cache, power supplies, clock circuits, input/output (I/O) circuits, an analog to digital (A/D) converter and the like. The memory 206 contained within the module 103 may comprise random access memory, read only memory, removable disk memory, flash memory, hard drive, and various combinations of these types of memory. The memory 206 is sometimes referred to as main memory and may, in part, be used as cache memory or buffer memory. The memory 206 may include an encoder 208, encoding control software 210, media data 212 and dropped packets 214. The encoder 208 may alternatively be implemented as hardware, i.e., as a dedicated integrated circuit or as a portion of an integrated circuit. The encoding control software 210 enable the encoder 208 to encode media data in accordance to the controller's instructions. The encoding control software 210 facilitates communications between the media source 102, module 103 and the controller 106. The encoded media data is buffered prior to transmission as the media data 212 in the memory 206, e.g., one to two seconds of encoded media data is buffered. The encoder 208 may be implemented in software or hardware.

The module 103 can be integrated into or coupled to the media source by a cable or physically affixed to existing media source, such as, consumer DV camcorders or videoconferencing cameras, webcams, mobile phones, and/or video cameras. The module 103 enables convenient use of the media source 102 to capture and broadcast live video over a network or the Internet, and to create a recorded digital file on a remote or local server for later on-demand viewing. Thus, by adding the module 103 to an existing media source, such as, a video cameras, users can immediately distribute live or archived encoded media data to at least one user on the Internet, create files on a local or remote server through a network, and immediately make live and recorded media data available to Internet viewers without changing the media source 102 (i.e., legacy media sources can be used with a distribution system). In one embodiment, by adding the module 103 to an existing legacy media source 102, such as, video cameras, camcorder, or the like, users may immediately distribute live video to multiple users on the Internet, create files on a remote or local server through a network, and immediately make their live and recorded content available to Internet viewers.

The module 103 couples to the media source 102 via a connector such that the module receives a digital or analog output from the source. For example, the output may be DV/Firewire, S-Video, composite, USB, SDI and the like. The media signal may be coupled to the module 103 via a wired (e.g., cable) or wireless (e.g., BLUETOOTH, WiFi, WiMAX, and the like) connection. The module 103 may capture and may encode the encoded media data and temporarily stores the media data 212 in memory 206 during the transmission process. Additionally, the module 103 stores dropped packets for retransmission as disclosed below. To facilitate encoding of an analog media signal, the module 103 may contain an A/D converter as a support circuit 204. The module 103 may send the encoded media data as a multicast transmission to the network, send the media data as a unicast transmission to a remote or a local server to be recorded, send the media data in a unicast transmission to a remote or a local server to be reflected and distributed to live or in playback to the viewers utilizing the user devices.

The CPU 202 of the module 103 may collaborate with the controller to alter the encoding process in view of variations in the distribution environment as well as to facilitate lossless packet transmission. Thus, the CPU 202 controls encoding parameters used by the encoder 208 according to a control signal.

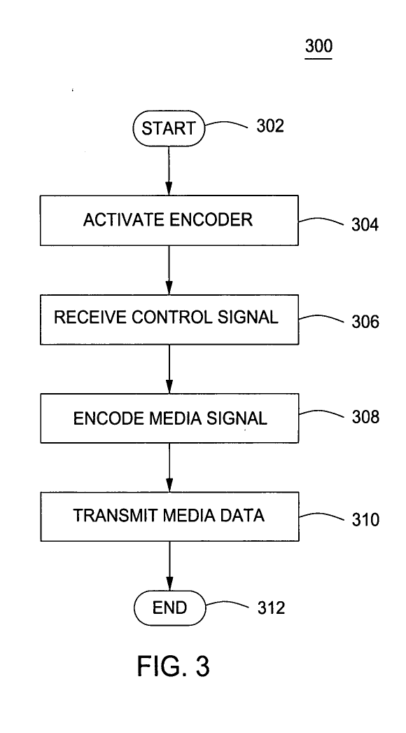

FIG. 3 is a flow diagram depicting an exemplary embodiment of a method 300 of operation of the encoding module. The method 300 starts at step 302 and proceeds to step 304. At step 304, the module activates the encoder. The controller collaborates with the module to determine a control signal. In one embodiment, the control signal comprises encoding control parameters; in another embodiment, the control signal comprises a request for dropped packets; and in a further embodiment, both a request for dropped packets and encoding parameters are included in the control signal. At step 306, the module receives the control signal. The module may receive the control signal, step 306, before activating the encoder, step 304. At step 308, the module encodes the media signals provided by the media source to form media data in compliance with the control signal. At step 310, the module transmits the encoded media data. The method 300 ends at step 312.

More specifically, the control signal includes encoding parameters. In one embodiment, the encoding parameters that are determined for an optimized transmission are:
C=Codecs for video and audio. The codecs can be characterized by their compression efficiency (quality/bitrate) and their encoding complexity (CPU cycles required per encoded pixel)
F=Framerate and audio sampling frequency
B=Bitrate
Re=Encoding Resolution
Any other parameter may include, b-frames, cabac, and the like.

For example, a user wishing to produce media data is only required to press a button to start an encoder, and the encoding settings are automatically set based on the hardware and the network environment used to encode and distribute the media signals. In this way, the user will have the best visual quality possible given the environment without knowledge of the encoding settings.

If F is the function to determine the encoding parameters given the environment at time t:

(C,F,B,Re)=F(S,P,R,D)(t)

F is a function of the environment (CPU power, network uplink speed, etc) and of the time t since CPU resources and the network environment change dynamically.

F can be computed deterministically or through a cost function with statistic models and Monte Carlo analysis.

Periodically, the controller uses the function F to calculate the optimal set of encoding settings given the environment at time t and a command is sent to the encoder to adjust its encoding parameters while still encoding the live media. This allows the encoding bitrate curve to follow the dynamic bandwidth capacity of the network link to avoid rate distortions.

Below is an example of logic that can be used to compute F(t) and determine the best set (C,F,B,Re).

In general, the main constraint to optimal transmission is the upstream speed of the network link between the media source and the controller. This upstream speed provides a maximum limit to the bitrate that is used to distribute the live multimedia content. To account for overhead and variance of the bitrate, the overall bitrate (video+audio) is set at a percentage of the measured available bandwidth (for example 80% of the measured available bandwidth). For a more accurate measure, this percentage may be set based on a measured or predicted statistical distribution of the upstream speed. Once the bitrate is chosen, the algorithm may choose a corresponding set of resolution, framerate, and codec that will provide good quality media data.

For a given codec, empirical measures enable the determination of the general characteristics of any particular codec: Bitrate per pixel needed for good frame visual quality (for example with no visible artifacts), and CPU cycles per pixel needed to encode media in real time. This value measures the performance of the encoder in terms of encoding complexity.

The CPU cycle cost required to perform resizing of the video can also be taken into account in the optimization calculation (in particular when it is necessary to encode at a lower resolution than the native resolution of the capture device for a better visual quality vs. resolution).

The controller measures the available CPU power of the module 103 and uses the information as a metric for optimizing the encoding process. This imposes an additional constraint on F(t): the encoding parameters should be chosen such that the number of CPU cycles required to encode the media is within the capabilities of the encoding machine. Failure to do so would exceed the CPU usage limit of the encoding device and result in lost frames and non-optimal quality of the encoded media data.

As an example, suppose there are two codecs available in the module 103, H.264 and MPEG-4 SP:
1) H.264 is more efficient in terms of quality vs. bitrate but its encoding complexity is higher (requires more CPU cycles to be utilized to encode video).
2) MPEG-4 SP is less efficient in terms of quality vs. bitrate but it is less complex (requires less CPU cycles to be utilized to encode video).

Although H.264 is generally considered a better codec, in the sense that it is more efficient for quality vs. bit rate, it will be better to use MPEG-4 SP in some cases. For example, if the media source has a very low CPU power but the storage of the controller has high capacity, MPEG-4 SP may be preferred.

Additional constraints can be utilized to computate F(t), in particular if the target playback device (user device) only supports a few specific resolutions or codecs, such information should be used to optimize F(t).

Each codec (H.264, MPEG-4 SP) has a different computational cost, the assumption used to optimize F(t) is that this cost is proportional to the size of a video frame in pixels.

CPU use by an encoding technique can be calculated using the following formula: F*P*R=C; where:

F=frames per second

P=Pixels per frame

R=Cycles per pixel

C=CPU cycles

### F, P, and C are measurable, such that using the following formula, R can be determined.

R=C/(F*P)

For example, the following data was gathered on a PC with CPU speed of 2791 MHz:

| Codec | width | height | Fps | bitrate | CPU % |
|---|---|---|---|---|---|
| H.264 | 320 | 240 | 1 | 200000 | 24 |
| | | | 2 | | 26 |
| | | | 4 | | 28 |
| | | | 8 | | 35 |
| | | | 15 | | 48 |
| | 176 | 144 | 1 | | 15 |
| | | | 2 | | 17 |
| | | | 4 | | 19 |
| | | | 8 | | 20 |
| | | | 15 | | 23 |
| MPEG-4 | 320 | 240 | 1 | | 20 |
| SP | | | | | |
| | | | 2 | | 22 |
| | | | 4 | | 23 |
| | | | 8 | | 25 |
| | | | 15 | | 32 |
| | 176 | 144 | 1 | | 10 |
| | | | 2 | | 11 |
| | | | 4 | | 13 |
| | | | 8 | | 15 |
| | | | 15 | | 16 |

Using the forgoing data to solve for R reveals the following:

R(H.264)=904

R(MPEG-4 SP)=578.5

Consequently, for this computer, H.264 encoding requires substantial more cycles per pixel to encode video when compared to encoding with MPEG-4 SP. This information can be used to optimize F(t).

In another embodiment of the invention, the controller may gather further data from its users about CPU consumption and system characteristics of different machines (both user devices and media source). These characteristics can also be measured and calibered by encoding a small amount of data on the CPU. User CPU data may be used to further refine the CPU consumption model, allowing for accurate prediction relating to CPU consumption on a wide variety of machines.

The foregoing described dynamically choosing the ideal encoding settings based on the hardware and network environment, however, in some cases, there may still be some packet losses in the transmission between the media source and the controller. Such packet losses cause a stored file to be missing data, and result in a permanently degraded quality of the stored file. This is particularly a problem since the purpose of storing the file is to host and serve the file on-demand for future viewers.

To address this issue in another embodiment of the invention, the controller 106 utilizes a Real-time Transport Protocol (RTP) to transfer media data from the module 103 to the controller. Because RTP data packets are numbered, it is easy for the controller to identify which packets, if any, have been lost during the storage (or RTP capture) process. Every time the controller detects that a packet was not received in time, the controller requests the module 103 to save the lost packet for later transmission. A sliding window buffer implemented within the memory of the module 103 maintains RTP packets 214 for an amount of time sufficient to determine whether such packets were received or lost. Once the status of a particular packet is known, the packet is either saved for later transmission or, if transmission was successful, discarded from the buffer.

During or at the end of the live broadcast, the module 103 sends all the identified lost packets stored in the buffer to the controller which reconstitutes the file. The lost packets may not be retransmitted in time for (or used in) real-time rendering during the live broadcast, since the goal is reconstitute a storage copy. Because of the rate adaptation that was described above, the packet losses are minimized. Therefore, the set of all lost packets (Δ) that are sent to the controller is small, minimizing the transfer time and assuring that the final stored file is available immediately after the end of the broadcast.

Δ=(total set of RTP packets sent by the media source)−(set of RTP packets received by the controller)

Note that this “post encoding packet recovery” method potentially allows the system 100 (FIG. 1) to encode at a higher bitrate than the capacity of the network, while producing an accurate file on the remotely located controller 106. Compared to the case where the bitrate is adapted to the network capacity, this technique would increase the size of Δ and therefore the size of temporary storage space needed in the module side to store the lost packets, and also it would delay the availability of the final stored file on the controller since more time will be required to transfer Δ. But this could also be used as a method to perform high quality encodings while significantly reducing the time needed to make the file available on the controller for on-demand delivery.

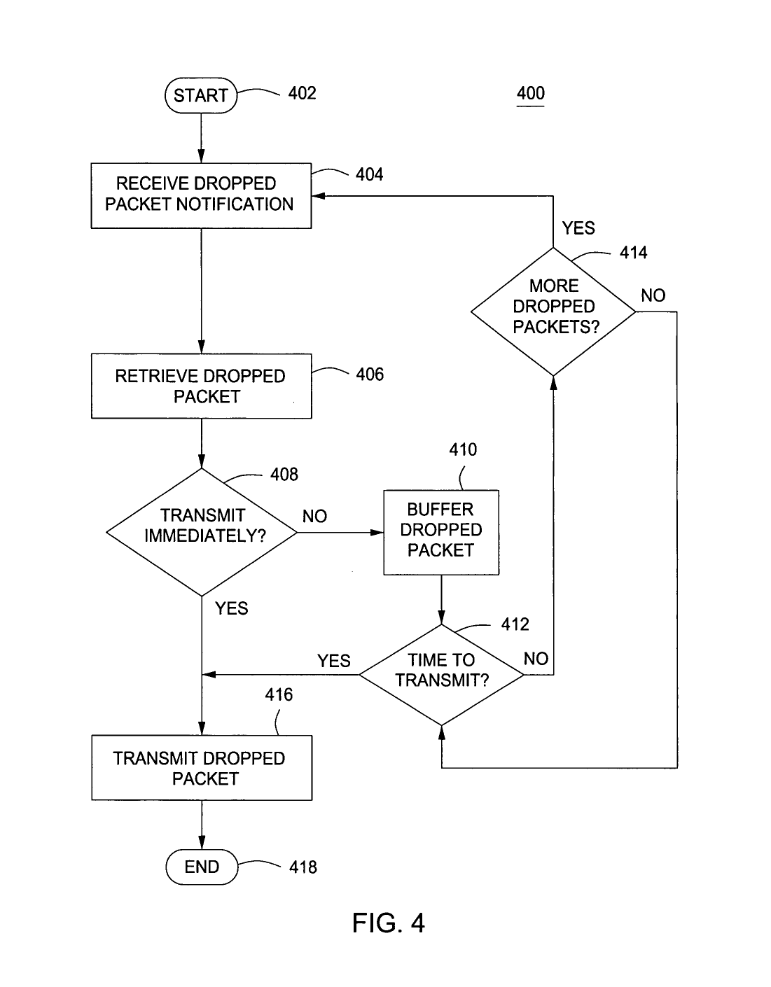

FIG. 4 is a flow diagram depicting an exemplary embodiment of a method 400 of a module re-sending dropped media data packets. The method 400 starts at step 402 and proceeds to step 404. At step 404, the module receives dropped media data packet notification i.e., a request to send dropped packets. At step 406, the module retrieves the dropped media data packet from the buffer, e.g., one to two seconds of data is buffered, utilizing the identification information received in the notification of step 404. Once a particular packet is requested, the packet is moved from the buffer to a dropped packet file; other packets in the buffer that are not to be resent are discarded. At step 408, the module queries whether the dropped media data packet is to be transmitted immediately, i.e., the notification may indicate that the dropped packet should be sent immediately. If the dropped packet is not to be transmitted immediately, the method 400 continues to step 410. At step 410, the module stores the dropped media data packet in a file for transmission at a later time. At step 412, the module queries whether it is time to transmit the archived dropped media data packet, e.g., has the transmission of the media data ended. If it is time, the method 400 proceeds to step 416. If it is not time to transmit the dropped packet, the method 400 proceeds to step wherein the module queries if there is another dropped media data packet notification. If there is not another dropped packet, the method 400 proceeds to step 412. If there is another dropped media data packet notification, the method 400 proceeds to step 404. At step 408, if the dropped media data packet is to be transmitted immediately, the method 400 proceeds to step 416. At step 416, the module transmits at least one dropped media data packet through the network to the controller. The method 400 ends at step 418.

While various embodiments have been described above, it should be understood that they have been presented by way of example only, and not limitation. Thus, the breadth and scope of a preferred embodiment should not be limited by any of the above-described exemplary embodiments, but should be defined only in accordance with the following claims and their equivalents.

What is claimed is:

1. An apparatus for encoding and distributing media signals, comprising:
a module for encoding media signals to form media data that is distributed through a communications network, wherein the module performs an encoding process in response to a control signal generated by a controller operating in collaboration with the module.

2. The apparatus of claim 1, wherein the module distributes at least a portion of the media data to at least one controller.

3. The apparatus of claim 1, wherein the control signal comprises a request for dropped packets.

4. The apparatus of claim 1, wherein the module comprises a buffer for temporarily storing packets of media data that can be requested for retransmission as dropped packets.

5. The apparatus of claim 1, wherein the control signal comprises encoding parameters that are generated by analyzing environmental characteristics for encoding and distributing the media data and specifies the encoding parameters in response to specific environmental characteristics.

6. The apparatus of claim 1, wherein the media data is at least one of a video data, an audio data, or a photograph data.

7. The apparatus of claim 5 wherein the control signal is dynamically adapted.

8. The apparatus of claim 1 further comprising:
a controller, coupled to the module, for distributing the media data.

9. The apparatus of claim 1 wherein the module further comprises a wireless transceiver for coupling the media data to the communications network.

10. The apparatus of claim 9 wherein the wireless transceiver uses at least one wireless protocol including BLUETOOTH, WiFi, and WiMAX.

11. A method of encoding and distributing media signals, comprising:
generating a control signal through collaboration between a controller and a module, where the control signal is dynamically adapted to an encoding and distributing environment;
coupling the control signal to the module; and
encoding media signals to form media data and distributing the media data in response to the control signal.

12. The method of claim 11 further comprising:
receiving media signals from a legacy media source.

13. The method of claim 11 wherein the media signals are analog or digital.

14. The method of claim 11 further comprising transmitting the encoded media data from the module to the controller.

15. The method of claim 11 wherein the control signal comprises a dropped media data packet notification.

16. The method of claim 11, wherein the generating step analyzes at least one bandwidth, bitrate, framerate, audio frequency, encoding resolution, or the media source, or the module computer power

17. The method of claim 11, wherein the encoded media data is at least one of a video data, an audio data, or a photograph data.

18. The method of claim 11 further comprising communicating with the controller via a wireless transceiver.

19. An add-on module for use in a system for encoding and broadcasting streaming media via network, said system including a media source and a remote server system, said add-on module comprising:
(a) an encoder, coupled to receive video data from the media source and operable to encode said video data for streaming;
(b) a transmitter, operable to wirelessly transmit network data packets; and
(c) a processor operable to cause the transmitter to wirelessly stream encoded data, as the encoded data is produced by the encoder, to the remote server system via the network;
wherein the combined add-on module and the media source as affixed to each other are handheld, and wherein the remote server system is operative, as the encoded media is received, to record a copy of the encoded data and to stream the encoded data via the network to a plurality of user devices.

20. The apparatus of claim 19, wherein the transmitter is operable to transmit over a wireless Internet Protocol network.

21. The apparatus of claim 19, wherein the encoder receives the video data from the media source through at least one connection.

22. The apparatus of claim 19, wherein the connection is at least one of a universal serial bus (USB), FireWire and analog connection.

23. The apparatus of claim 19, wherein the module is built into a device.

24. The apparatus of claim 19, wherein the device is at least one of a camcorder, mobile phone, a webcam, a camera, and a PDA.
